(19) United States
(12) Patent Application Publication
(10) Pub. No.: US 2024/0343201 A1
(43) Pub. Date: Oct. 17, 2024

(54) TIRE CHAIN STORAGE APPARATUS

(71) Applicant: Timothy Thomas Pearson, Quesnel (CA)

(72) Inventor: Timothy Thomas Pearson, Quesnel (CA)

(21) Appl. No.: 18/299,978

(22) Filed: Apr. 13, 2023

(51) Int. Cl. B60R 9/00

(52) U.S. Cl. CPC B60R 9/00

(57) ABSTRACT

A tire chain storage apparatus that is configured to be operably coupled to a vehicle and provide storage of tire chains. The invention includes a mounting plate that has a horizontal support member extending outward therefrom being perpendicular thereto. Movably coupled to the horizontal support member is a roller support member that is operable to traverse bi-directionally along the horizontal support member. A lower support bar member is operably coupled to the lower end of the roller support member wherein the lower support bar member is beneath and axially aligned with the horizontal support member. A plurality of tire chain support members are operably coupled to the lower support bar member and are configured to receive and retain a tire chain. The lower support bar member has secured thereto an engagement member that is configured to allow a user to move the present invention between its first and second position.

### FIELD OF THE INVENTION

The present invention relates generally to vehicle accessories and equipment, more specifically but not by way of limitation, an apparatus configured to be mounted to a truck or trailer thereof wherein the apparatus is operable to store tire chains when not in use on the tires of the truck or trailer.

### BACKGROUND

As is known in the art, in some areas during snow and ice conditions it is either advisable or required by law to either have a vehicle equipped with a special tire or utilize chains on the tires. In some regions it may be required to drive with the special tires or chains during a regulated period of time when snow and ice conditions are routine. For larger commercial trucks the operators thereof will commonly utilize tire chains in order to ensure safety while driving on snow and ice. These chains surroundably mount the tires and provide improved traction to reduce the probability of losing control of the vehicle.

While the chains are effective for their task, the handling of them can be quite cumbersome. An operator of a commercial truck must keep the chains accessible for periods of time or occasions when the chains need to be mounted to the tires. Certain trucks may need four or more tire chains and storage of these tire chains can be a challenge. If thrown into a conventional storage compartment the tire chains can often become entangled and when needed this can present a delay in installation of the tire chains. While some vehicles have tire chain storage devices, they can be cumbersome and not efficiently carry and store a large number of tire chains.

Accordingly, there is a need for a tire chain storage device that is configured to be secured to a vehicle wherein the present invention provides improved storage and access to the tire chains.

### SUMMARY OF THE INVENTION

It is the object of the present invention to provide a tire chain storage apparatus configured to be secured to a vehicle or trailer wherein the present invention includes a mounting plate and a horizontal support member extending outward therefrom and perpendicular thereto.

Another object of the present invention is to provide an apparatus operable to provide storage of tire chains and make accessible for use thereof wherein the present invention further includes a roller support member wherein the roller support member is operably coupled to the horizontal support member having a portion extending downward therefrom.

A further object of the present invention is to provide a tire chain storage apparatus configured to be secured to a vehicle or trailer wherein the lower end of the roller support member is operably coupled to a support bar member wherein the support bar member extends outward from the lower end of the roller support member and is parallel and beneath the horizontal support member.

Yet a further object of the present invention is to provide an apparatus operable to provide storage of tire chains and make accessible for use thereof wherein the support bar member has operably coupled thereto a plurality of tire chain support members.

Still another object of the present invention is to provide a tire chain storage apparatus configured to be secured to a vehicle or trailer wherein the support bar member includes an engagement member secured to the end of the support bar member distal to the lower end of the roller support member.

An additional object of the present invention is to provide an apparatus operable to provide storage of tire chains and make accessible for use thereof wherein the tire chain support members include leg members extending upward from the support bar member having a void therebetween.

Yet a further object of the present invention is to provide a tire chain storage apparatus configured to be secured to a vehicle or trailer wherein the support bar member is movable between a first position and a second position.

To the accomplishment of the above and related objects the present invention may be embodied in the form illustrated in the accompanying drawings. Attention is called to the fact that the drawings are illustrative only. Variations are contemplated as being a part of the present invention, limited only by the scope of the claims.

### BRIEF DESCRIPTION OF THE DRAWINGS

A more complete understanding of the present invention may be had by reference to the following Detailed Description and appended claims when taken in conjunction with the accompanying Drawings wherein:

FIG. 1 is a side view of the present invention in its first position; and

FIG. 2 is a detailed view of a tire chain support member of the present invention; and

FIG. 3 is a front perspective view of the present invention in its second position; and

FIG. 4 is a front perspective view of the present invention in its first position.

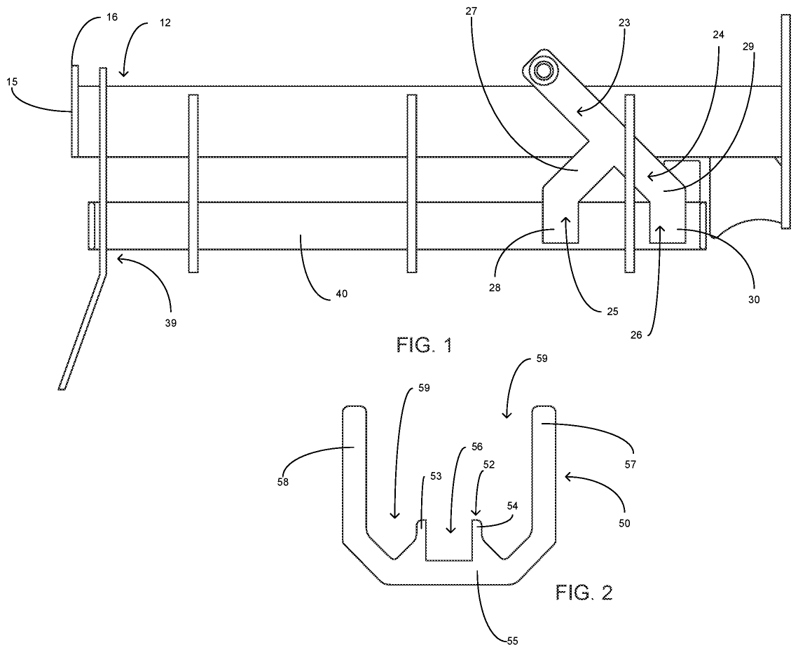

### DETAILED DESCRIPTION

Referring now to the drawings submitted herewith, wherein various elements depicted therein are not necessarily drawn to scale and wherein through the views and figures like elements are referenced with identical reference numerals, there is illustrated a tire chain storage apparatus 100 constructed according to the principles of the present invention.

An embodiment of the present invention is discussed herein with reference to the figures submitted herewith. Those skilled in the art will understand that the detailed description herein with respect to these figures is for explanatory purposes and that it is contemplated within the scope of the present invention that alternative embodiments are plausible. By way of example but not by way of limitation, those having skill in the art in light of the present teachings of the present invention will recognize a plurality of alternate and suitable approaches dependent upon the needs of the particular application to implement the functionality of any given detail described herein, beyond that of the particular implementation choices in the embodiment described herein. Various modifications and embodiments are within the scope of the present invention.

It is to be further understood that the present invention is not limited to the particular methodology, materials, uses and applications described herein, as these may vary. Furthermore, it is also to be understood that the terminology used herein is used for the purpose of describing particular embodiments only, and is not intended to limit the scope of the present invention. It must be noted that as used herein and in the claims, the singular forms “a”, “an” and “the” include the plural reference unless the context clearly dictates otherwise. Thus, for example, a reference to “an element” is a reference to one or more elements and includes equivalents thereof known to those skilled in the art. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

References to “one embodiment”, “an embodiment”, “exemplary embodiments”, and the like may indicate that the embodiment(s) of the invention so described may include a particular feature, structure or characteristic, but not every embodiment necessarily includes the particular feature, structure or characteristic.

Referring in particular to the Figures submitted herewith, the tire chain storage apparatus 100 is operable to be secured to a vehicle such as but not limited to a large commercial truck and provide storage of tire chains. It should be understood within the scope of the present invention that the tire chain storage apparatus 100 could be provided in alternate sizes, mounted in various location on a vehicle and further be configured to receive and store and alternate quantity of tire chains.

The tire chain storage apparatus 100 includes a mounting plate 5 wherein the mounting plate 5 is secured to a suitable support surface on a vehicle utilizing suitable techniques such as but not limited to welding. The mounting plate 5 is manufactured from metal and has a horizontal support member 10 operably coupled thereto. The horizontal support member 10 is perpendicular to the mounting plate 5 extending outward therefrom. The horizontal support member 10 includes a first end 11 and second end 12 and is elongated and rectangular in shape. Support plate 14 is secured to mounting plate 5 and lower surface 13 of the horizontal support member 10. Support plate 14 provides structural support for the configuration of the horizontal support member 10. Secured to the second end 12 of the horizontal support member 10 is stop plate 15. Stop plate 15 includes an upper edge 16 that is above the upper surface 9 of the horizontal support member 10 so as to inhibit the roller support member 20 from traversing therepast.

The roller support member 20 is movably coupled to the horizontal support member 10 and is operable to traverse bi-directionally along the length of the horizontal support member 10. The roller support member 20 includes a first support member 21 and a second support member 22 that are positioned on opposing sides of the horizontal support member 10. The first support member 21 and second support member 22 are operably coupled at the upper ends thereof with roller member 23. Roller member 23 is superposed the upper surface 9 of the horizontal support member 10 and is operable to provide movement of the roller support member 20 along the horizontal support member 10. While a roller member 23 has been illustrated and discussed herein, it should be understood within the scope of the present invention that the roller support member 20 could be configured with alternate elements operable to provide the desired movement thereof. The first support member 21 and second support member 22 are identical in shape and form and as such the foregoing detailed discussion on the first support member 21 should be understood to apply to the second support member. The first support member 21 includes an upper portion 23 that is angularly oriented with respect to the horizontal support member 10 extending downward and towards the mounting plate 5. Contiguously formed with the upper portion 23 is lower portion 24 having a first segment 25 and a second segment 26. First segment 25 includes sections 27,28 wherein section 27 is perpendicular to upper portion 23. Second segment 26 includes sections 29, 30 wherein section 29 is contiguous with upper portion 23. Sections 28,30 are oriented so as to be parallel with each other having a void 32 therebetween. The configuration of the first support member 21 and second support member 22 of the roller support member 20 provides the necessary structural integrity to support weight of a plurality of tire chains when the tire chain storage apparatus 100 is moved to its second position. While a preferred embodiment of the roller support member 20 is illustrated herein, it is contemplated within the scope of the present invention that the roller support member 20 could be manufactured in alternate manners and achieve the desired objective discussed herein.

The roller support member 20 operably couples the lower support bar member 40 to the horizontal support member 10. The lower support bar member 40 is manufactured from a suitable material such as but not limited to square metal tubing and is coupled to the roller support member utilizing suitable techniques such as but not limited to welding. The lower support bar member 40 is axially aligned with the horizontal support member 10 and is suspended underneath the horizontal support member 10. In the first position of the tire chain storage apparatus 100 the lower support bar member 40 is substantially underneath the horizontal support member 10. In the second position of the tire chain storage apparatus 100 the lower support bar member 40 is extend outward from underneath the horizontal support bar member 10.

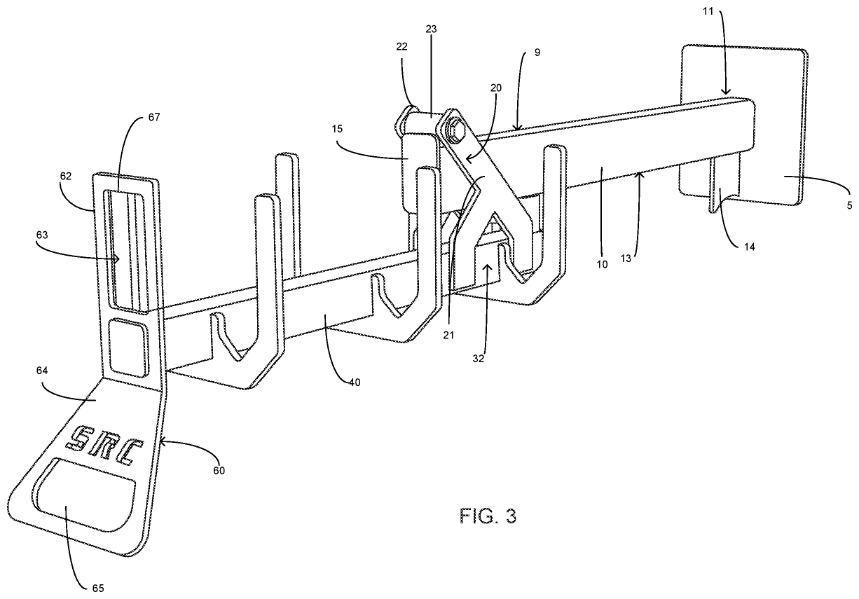

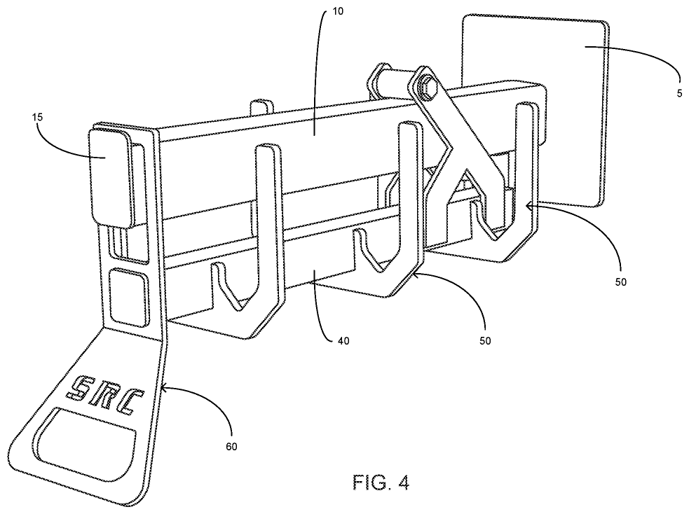

The tire chain storage apparatus 100 includes a plurality of tire chain support members 50. The tire chain support members 50 are configured to receive and retain tire chains for storage thereof. Illustrated in FIG. 2 submitted herewith is a detailed view of a tire chain support member 50. The tire chain support member 50 is generally u-shaped having central connection member 52 located at the bottom thereof. Central connection member 52 includes support members 53, 54 extending upward from the bottom section 55 wherein a void 56 is present intermediate the support members 53,54. The void 56 is sized so as to mateably coupled with the lower support bar member 40 and be secured thereto with suitable techniques such as but not limited to welding. Tire chain support member 50 includes first upper leg member 57 and second upper leg member 58. First upper leg member 57 and second upper leg member 58 are contiguously formed with bottom section 55 on opposing ends thereof and extend upward therefrom. The first upper leg member 57 and second upper leg member 58 are positioned when the tire chain support member 50 is mounted to the lower support bar member 40 to have a void 59 between the first upper leg member 57 and the lower support bar member 40. The same void 59 is present between the second upper leg member 58 and the lower support bar member 40. Void 59 is of suitable size to accommodate a portion of a tire chain therein so as to facilitate the tire chain support member 50 receiving and storing tire chains. While a particular shape of the tire chain support members 50 have been illustrated herein, it is contemplated within the scope of the present invention that the tire chain support members 50 could be manufactured in alternate shapes and achieve the desired objective discussed herein. It should be further understood that the tire chain storage apparatus 100 could have as few as one tire chain support member 50 or more than three as is illustrated in the embodiment in the Figures submitted herewith.

Secured to the second end 39 of the lower support bar member 40 is engagement member 60. Engagement member 60 is operable to provide an interface for a user to move the tire chain storage apparatus 100 in between its first position and second position. The engagement member 60 includes an upper portion 62 and a lower portion 64. The lower portion 64 is contiguous with the upper portion 62 wherein the lower portion 64 is angularly oriented with the upper portion 62 and extends outward from the lower support bar member 40. The lower portion 64 includes aperture 65 that is of suitable size to be grasped by a hand of the user of the tire chain storage apparatus 100 so as to facilitate movement of the tire chain storage apparatus 100 between its first position and its second position. The upper portion 62 of the engagement member 60 includes aperture 63 wherein aperture 63 includes upper edge 67. The aperture 63 is formed so as to be able to have the horizontal support member 10 journaled therethrough. The upper edge 67 of the aperture 63 is configured to be below the upper edge 16 of the stop plate 15 so as to maintain the tire chain storage apparatus 100 in in its first position. It should be understood within the scope of the present invention that the tire chain storage apparatus 100 could employ alternate elements to maintain the tire chain storage apparatus 100 in its first position. By way of example but not limitation, a spring biased pin or similar element could be employed to maintain the tire chain storage apparatus 100 in its first position.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical changes may be made without departing from the spirit or scope of the invention. The description may omit certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

What is claimed is;:

1. A tire chain storage apparatus configured to be operably coupled to a vehicle and provide storage of tire chains wherein the tire chain storage apparatus comprises:
a mounting plate, said mounting plate being secured to a suitable support surface of the vehicle;
a horizontal support member, said horizontal support member being elongated in form having a first end and a second end, said horizontal support member having an upper surface, said first end of said horizontal support member being proximate said mounting plate;
a roller support member, said roller support member being movably coupled to said horizontal support member, said roller support member configured to traverse bi-directionally along said upper surface of said horizontal support member, said roller support member having a first support member and a second support member extending downward from said horizontal support member;
a lower support bar member, said lower support bar member being operably coupled to said first support member and said second support member of said roller support member distal to said horizontal support member, said lower support bar member having a first end and a second end, said lower support bar member being beneath and axially aligned with said horizontal support member;
at least one tire chain support member, said at least one tire chain support member being operably coupled to said lower support bar member, said at least one tire chain support member having a first upper leg member and a second upper leg member, said first upper leg member and said second upper leg member extending upward from said lower support bar member, said first upper leg member and said second upper leg member being on opposing sides of said lower support bar member and having a void therebetween; and
wherein the tire chain storage apparatus is movable between a first position and a second position.

2. The tire chain storage apparatus configured to be operably coupled to a vehicle and provide storage of tire chains as recited in claim 1, and further including an engagement member, said engagement member being secured to said second end of sad lower support bar member, said engagement member operable to provide an interface to move the tire chain storage apparatus from its first position to its second position.

3. The tire chain storage apparatus configured to be operably coupled to a vehicle and provide storage of tire chains as recited in claim 2, wherein said first support member of said roller support member includes an upper portion and a lower portion, said upper portion and said lower portion being contiguously formed, said upper portion being angularly mounted with respect to said horizontal support member, said lower portion having a first segment and a second segment, said first segment and said second segment having a void therebetween, said first segment and said second segment being secured to said lower support bar member.

4. The tire chain storage apparatus configured to be operably coupled to a vehicle and provide storage of tire chains as recited in claim 3, and further including a roller member, said roller member being operably coupled between said first support member and said second support member of said roller support member, said roller member being superposed said upper surface of said horizontal support member, said roller member configured to traverse bi-directionally along the upper surface of said horizontal support member.

5. The tire chain storage apparatus configured to be operably coupled to a vehicle and provide storage of tire chains as recited in claim 4, wherein said second support member of said roller support member includes an upper portion and a lower portion, said upper portion and said lower portion of said second support member being contiguously formed, said upper portion of said second support member being angularly mounted with respect to said horizontal support member, said lower portion of said second support member having a first segment and a second segment, said first segment and said second segment of said lower portion of said second support member having a void therebetween, said first segment and said second segment of said lower portion of said second support member being secured to said lower support bar member.

6. The tire chain storage apparatus configured to be operably coupled to a vehicle and provide storage of tire chains as recited in claim 5, wherein said engagement member includes an upper portion and a lower portion, said upper portion having an aperture, said aperture operable to engage with a stop plate mounted to said second end of said horizontal support member so as to maintain the tire chain storage apparatus in the first position.

7. The tire chain storage apparatus configured to be operably coupled to a vehicle and provide storage of tire chains as recited in claim 6, said tire chain support member having a central connection member, said central connection member configured to operably couple to the lower support bar member adjacent a lower surface thereof.

8. A tire chain storage apparatus configured to be operably coupled to a tractor trailer style truck and provide storage of tire chains wherein the tire chain storage apparatus comprises:
a mounting plate, said mounting plate being secured to a suitable support surface of the vehicle;
a horizontal support member, said horizontal support member being elongated in form having a first end and a second end, said horizontal support member having an upper surface, said first end of said horizontal support member being proximate said mounting plate;
a roller support member, said roller support member being movably coupled to said horizontal support member, said roller support member configured to traverse bi-directionally along said upper surface of said horizontal support member, said roller support member having a first support member and a second support member extending downward from said horizontal support member, wherein said first support member of said roller support member includes an upper portion and a lower portion, said upper portion and said lower portion being contiguously formed, said upper portion being angularly mounted with respect to said horizontal support member, said lower portion having a first segment and a second segment, said first segment and said second segment having a void therebetween, said first segment and said second segment being secured to said lower support bar member, wherein said second support member of said roller support member includes an upper portion and a lower portion, said upper portion and said lower portion of said second support member being contiguously formed, said upper portion of said second support member being angularly mounted with respect to said horizontal support member, said lower portion of said second support member having a first segment and a second segment, said first segment and said second segment of said lower portion of said second support member having a void therebetween, said first segment and said second segment of said lower portion of said second support member being secured to said lower support bar member, said roller support member having a roller member, said roller member being operably coupled between said first support member and said second support member of said roller support member, said roller member being superposed said upper surface of said horizontal support member, said roller member configured to traverse bi-directionally along the upper surface of said horizontal support member;
a lower support bar member, said lower support bar member being operably coupled to said first support member and said second support member of said roller support member distal to said horizontal support member, said lower support bar member having a first end and a second end, said lower support bar member being beneath and axially aligned with said horizontal support member;
at least one tire chain support member, said at least one tire chain support member being operably coupled to said lower support bar member, said at least one tire chain support member having a first upper leg member and a second upper leg member, said first upper leg member and said second upper leg member extending upward from said lower support bar member, said first upper leg member and said second upper leg member being on opposing sides of said lower support bar member and having a void therebetween;
an engagement member, said engagement member being secured to said second end of sad lower support bar member, said engagement member operable to provide an interface to move the tire chain storage apparatus from its first position to its second position, wherein said engagement member includes an upper portion and a lower portion, said upper portion having an aperture, said aperture operable to engage with a stop plate mounted to said second end of said horizontal support member so as to maintain the tire chain storage apparatus in the first position; and
wherein the tire chain storage apparatus is movable between a first position and a second position.
